(19) United States
(12) Patent Application Publication
(10) Pub. No.: US 2017/0169786 A1
(43) Pub. Date: Jun. 15, 2017

(54) DISPLAY PANEL AND GATE DRIVER STRUCTURE

(71) Applicant: Shenzhen China Star Optoelectronics Technology Co., Ltd., Shenzhen, Guangdong (CN)

(72) Inventor: Xiaoyu HUANG, Shenzhen, Guangdong (CN)

(21) Appl. No.: 14/907,304

(22) PCT Filed: Jan. 6, 2016
(86) PCT No.: PCT/CN2016/070304

§ 371 Date: Jan. 25, 2016

(30) Foreign Application Priority Data
Dec. 11, 2015 (CN) 201510923388.7

(51) Int. Cl. G09G 3/36; G02F 1/1345

(52) U.S. Cl. CPC G09G 3/3677; G02F 1/13454; G09G 2330/02; G09G 2300/0421

(57) ABSTRACT

The present application relates to a display panel, the display panel has a display area, a plurality of odd stage scan lines and even stage scan lines arranged sequentially in the display area, and non-display area located at two sides of the display area, and includes a plurality of odd stage gate COFs, disposed on a first side of the non-display area, each odd stage gate COF having a plurality of odd stage scan output channels corresponding to each of the odd stage scan lines respectively; and a plurality of even stage gate COFs, disposed on a second side opposite to the first side on the non-display area, each even stage gate COF having a plurality of even stage scan output channels corresponding to each of the even stage scan lines respectively.

### FIELD OF THE INVENTION

The present application relates to a display panel and a gate driver structure, and particularly to a display panel and a gate driver structure for a thin film transistor liquid crystal display (TFT-LCD).

### BACKGROUND OF THE INVENTION

Thin film transistor liquid crystal displays (TFT-LCD) are the main variety of current flat-panel displays. The main driving principle of a TFT-LCD is shown in

FIG. 1. The system board 1 connects an R/G/B three-color compressed signal, a control signal, and a power through a line material and a connector on a printed circuit board (PCB) 10, and PCB plate 10 is connected to a gate chip on film (G-COF) 12 and a display area 13 through a source chip on film (S-COF) 11, so that the LCD obtains the desired power and signal.

The signals transmitted between the S-COF 11 and the G-COF 12, and the signals between different G-COF are all completed by a wiring of a layout of a fan-out area 14. With the development of the requirement for a narrow border of the display panel, the space for the wiring of the fan-out area on the gate side gradually decreases, the wiring of the layout gets more difficult, and the width thereof continues to decrease, thus it is needed to provide a gate driver structure to reduce the wiring density of the fan-out area.

### SUMMARY OF THE INVENTION

The present application arranges the G-COF in the single side drive structure on two sides of the display panel, to increase the space of the wiring of the fan-out area of the fan-out area on the gate side, and uses outputs of a plurality of odd stage G-COFs as start signals of the even stage G-COFs, to achieve reducing the density of the wiring of the fan-out area.

A display panel is provided according to an embodiment of the present invention, having a display area, a plurality of odd stage scan lines and even stage scan lines arranged sequentially in the display area, and non-display area located at two sides of the display area. The panel includes a plurality of odd stage gate COFs, disposed on a first side of the non-display area, each odd stage gate COF having a plurality of odd stage scan output channels corresponding to each of the odd stage scan lines respectively; and a plurality of even stage gate COFs, disposed on a second side opposite to the first side on the non-display area, each even stage gate COF having a plurality of even stage scan output channels corresponding to each of the even stage scan lines respectively; wherein a first odd stage gate COF of the plurality of odd stage gate COFs sequentially drives each of the odd stage scan output channels according to a first start signal, and in the first odd stage gate COF, the first odd stage scan output channel outputs a scan drive signal to a first even stage gate COF of the plurality of even stage gate COFs through a first odd stage scan line, and uses the scan drive signal as a second start signal of the first even stage gate COF, to sequentially drive each of the even stage scan output channels.

Preferably, the odd stage gate COFs of the plurality of odd stage gate COFs other than the first odd stage gate COF drive each odd stage scan output channel correspondingly according to another scan drive signal.

Preferably, the even stage gate COFs of the plurality of even stage gate

COFs other than the first even stage gate COF drive each even stage scan output channel correspondingly according to another scan drive signal.

Preferably, a drive manner of each odd stage scan output channel of the plurality of odd stage gate COFs and each even stage scan output channel of the plurality of even stage gate COFs is driving each other alternatively.

Preferably, the first start signal comprises an initial pulse vertical signal, the initial pulse vertical signal being used as a start-up signal of each refreshed screen of the odd stage gate COF.

The present application provides a gate driver structure capable of reducing the wiring density of the fan-out area, increasing the space of the wiring, and reducing the difficulty of the wiring, thus raising the product quality and competitiveness.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 illustrates a diagram of a structure of a traditional gate driver panel;

FIG. 2 illustrates a diagram of a structure of a gate driver panel according to an embodiment of the present invention;

FIG. 3 illustrates a diagram of the detailed structure in FIG. 2; and

FIG. 4 illustrates a diagram of a waveform of a scan output channel of the G-COF in FIG. 3 working in the display panel.

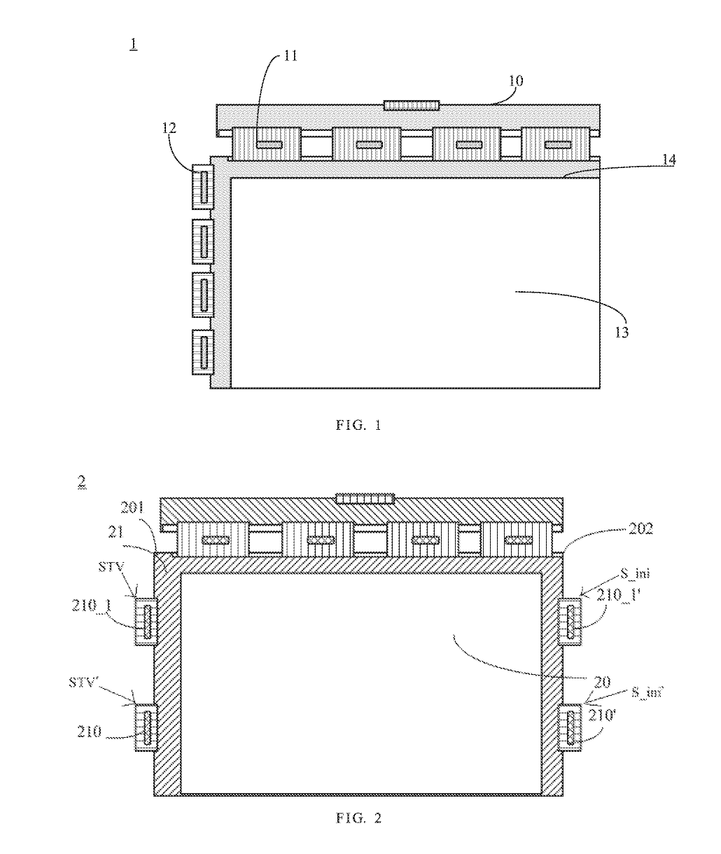

### DETAILED DESCRIPTION OF THE PREFERRED EMBODIMENTS

As used in this specification the term “embodiment” means that instance, an example or illustration. In addition, for the articles in this specification and the appended claims, “a” or “an” in general can be interpreted as “one or more” unless specified otherwise or clear from context to determine the singular form.

In the drawings, the same reference numerals denote units with similar structures.

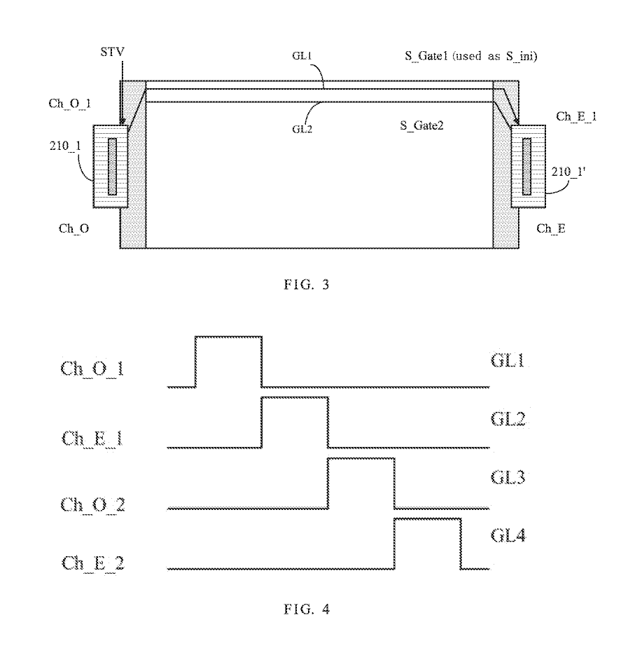

The present application arranges the G-COF in the single side drive structure on two sides of the display panel, to increase the space of the wiring of the fan-out area of the fan-out area on the gate side. Please refer to FIG. 2 and FIG. 3. FIG. 2 illustrates a diagram of a structure of a gate driver panel according to an embodiment of the present invention, and FIG. 3 illustrates a diagram of the detailed structure in FIG. 2. As shown in FIG. 2, a display panel 2 has a display area 20, a plurality of odd stage scan lines and even stage scan lines (like an odd stage scan line GL1 and an even stage scan line GL2), arranged sequentially in the display area 20, and non-display area 21 located at two sides of the display area 20. The panel 2 includes a plurality of odd stage gate COFs 210, disposed on a first side 201 of the non-display area 21, wherein each odd stage gate COF has a plurality of odd stage scan output channels Ch_O corresponding to each of the odd stage scan lines respectively; and a plurality of even stage gate COFs 210′, disposed on a second side 202 opposite the first side 201 on the non-display area 21, wherein each even stage gate COF 210′ has a plurality of even stage scan output channels Ch_E corresponding to each of the even stage scan lines respectively.

As shown in FIG. 3, a first odd stage gate COF COF 210_1 of the plurality of odd stage gate COFs 210 sequentially drives each of the odd stage scan output channels Ch_O according to a first start signal STV, and in the first odd stage gate COF 210_1, the first odd stage scan output channel Ch_O_1 outputs a scan drive signal S_Gate1 to a first even stage gate COF 210_1′ of the plurality of even stage gate COFs 210′ through a first odd stage scan line GL1, and uses the scan drive signal S_Gate1 as a second start signal S_ini of the first even stage gate COF 210_1′, to sequentially drive each of the even stage scan output channels Ch_E.

Preferably, the odd stage gate COFs 210 of the plurality of odd stage gate COFs other than the first odd stage gate COF 210_1 drive each odd stage scan output channel Ch_O correspondingly according to another scan drive signal STV′.

Preferably, the even stage gate COFs 210′ of the plurality of even stage gate COFs other than the first even stage gate COF 210_1′ drive each even stage scan output channel Ch_E correspondingly according to another scan drive signal S_ini′.

Preferably, a drive manner of each odd stage scan output channel Ch_O of the plurality of odd stage gate COFs 210 and each even stage scan output channel Ch_E of the plurality of even stage gate COFs 210′ is driving each other alternatively.

Preferably, the first start signal comprises an initial pulse vertical signal (start pulse vertical signal, STV), the initial pulse vertical signal being used as a start-up signal of each refreshed screen of the odd stage gate COF 210, for the G-COF, and once for each screen. When the first start signal STV is transmitted to the first odd G-COF 210_1, after the first odd G-COF 210_1 receives the first start signal STV, the scan drive signal S_Gate1 outputted is connected to the first even stage gate COF 210_1′ as the second start signal S_ini on the second side 202, and from the second output of the first odd G-COF 210_1, the output signal is only used as the turn-on signal of the gate, and not connected to the even stage G-COF on the second side 202. After a refreshed screen is completed, PCB generates a next first start signal, transmitted to the first odd G-COF 210_1, that is, in each screen, the first side 201 and the second side 202 only have a first start signal STV and a second start signal S_ini.

That is, using the scan output signal S_Gate1 of the first odd stage gate COF 210_1, as the second start signal S_ini of the first even stage gate COF 210_1′, it can be seen from FIG. 3, the first start signal STV is the start signal of the first odd stage gate COF 210_1, and the scan drive signal S_Gate1 outputted by the first odd stage gate COF 210_1; and the scan drive signal S_Gate1 is used as the second start signal S_ini of the G-COF 210_1′, and the scan drive signal outputted from the first even stage gate COF 210_1′ is signal S_Gate2.

FIG. 4 illustrates a diagram of a waveform of a scan output channel of the G-COF in FIG. 3 working in the display panel, wherein, the first odd stage scan output channel Ch_O_1 of the first odd stage gate COF 210_1 corresponds to the first odd stage scan line GL1, then the first even stage scan output channel Ch_E_1 of the first even stage gate COF 210_1′ corresponds to the even stage scan line GL2 next to the first odd stage scan line GL1, and sequentially, the second odd stage scan output channel Ch_O_2 of the G-COF 210_1 corresponds to the odd stage scan line GL3, and the second even stage scan output channel Ch_E_2 of the first even stage gate COF 210_1′ corresponds to the even stage scan line GL4 next to the odd stage scan line GL3.

The present application cooperating with a particular output timing of the G-COF, realizes the function of the G-COF, and changes the wiring space from single side to two sides to increase the wiring space for reducing the difficulty of the wiring, thereby increasing the product quality and the product competitiveness.

In summary, although the preferable embodiments of the present invention have been disclosed above, the embodiments are not intended to limit the present invention. A person of ordinary skill in the art, without departing from the spirit and scope of the present invention, can make various modifications and variations. Therefore, the scope of the invention is defined in the claims.

What is claimed is:

1. A display panel, having a display area, a plurality of odd stage scan lines and even stage scan lines arranged sequentially in the display area, and a non-display area located at two sides of the display area, the display panel comprising:
a plurality of odd stage gate chips on film (COFs), disposed on a first side of the non-display area, each odd stage gate COF having a plurality of odd stage scan output channels corresponding to each of the odd stage scan lines respectively; and
a plurality of even stage gate COFs, disposed on a second side opposite the first side on the non-display area, each even stage gate COF having a plurality of even stage scan output channels corresponding to each of the even stage scan lines respectively;
wherein a first odd stage gate COF of the plurality of odd stage gate COFs sequentially drives each of the odd stage scan output channels according to a first start signal, and in the first odd stage gate COF, the first odd stage scan output channel outputs a scan drive signal to a first even stage gate COF of the plurality of even stage gate COFs through a first odd stage scan line, and uses the scan drive signal as a second start signal of the first even stage gate COF, to sequentially drive each of the even stage scan output channels, and wherein the first start signal comprises an initial pulse vertical signal.

2. A display panel, having a display area, a plurality of odd stage scan lines and even stage scan lines arranged sequentially in the display area, and a non-display area located at two sides of the display area, the display panel comprising:
a plurality of odd stage gate COFs, disposed on a first side of the non-display area, each odd stage gate COF having a plurality of odd stage scan output channels corresponding to each of the odd stage scan lines respectively; and
a plurality of even stage gate COFs, disposed on a second side opposite the first side on the non-display area, each even stage gate COF having a plurality of even stage scan output channels corresponding to each of the even stage scan lines respectively;
wherein a first odd stage gate COF of the plurality of odd stage gate COFs sequentially drives each of the odd stage scan output channels according to a first start signal, and in the first odd stage gate COF, the first odd stage scan output channel outputs a scan drive signal to a first even stage gate COF of the plurality of even stage gate COFs through a first odd stage scan line, and uses the scan drive signal as a second start signal of the first even stage gate COF, to sequentially drive each of the even stage scan output channels.

3. The display panel of claim 2, wherein the odd stage gate COFs of the plurality of odd stage gate COFs other than the first odd stage gate COF drive each odd stage scan output channel correspondingly according to another scan drive signal.

4. The display panel of claim 2, wherein the even stage gate COFs of the plurality of even stage gate COFs other than the first even stage gate COF drive each even stage scan output channel correspondingly according to another scan drive signal.

5. The display panel of claim 2, wherein a drive manner of each odd stage scan output channel of the plurality of odd stage gate COFs and each even stage scan output channel of the plurality of even stage gate COFs is driving each other alternatively.

6. The display panel of claim 2, wherein the first start signal comprises an initial pulse vertical signal, the initial pulse vertical signal being used as a start-up signal of each refreshed screen of the odd stage gate COF.

7. A gate driver structure, located in a display panel, the display panel having a plurality of odd stage scan lines and even stage scan lines arranged sequentially, the gate driver structure comprising:
a plurality of odd stage gate COFs, disposed on a first side of the non-display area, each odd stage gate COF having a plurality of odd stage scan output channels corresponding to each of the odd stage scan lines respectively; and
a plurality of even stage gate COFs, disposed on a second side opposite to the first side on the non-display area, each even stage gate COF having a plurality of even stage scan output channels corresponding to each of the even stage scan lines respectively;
wherein a first odd stage gate COF of the plurality of odd stage gate COFs sequentially drives each of the odd stage scan output channels according to a first start signal, and in the first odd stage gate COF, the first odd stage scan output channel outputs a scan drive signal to a first even stage gate COF of the plurality of even stage gate COFs through a first odd stage scan line, uses the scan drive signal as a second start signal of the first even stage gate COF, to sequentially drive each of the even stage scan output channels.

8. The gate driver structure of claim 7, wherein the odd stage gate COFs of the plurality of odd stage gate COFs other than the first odd stage gate COF drive each odd stage scan output channel correspondingly according to another scan drive signal.

9. The gate driver structure of claim 7, wherein the even stage gate COFs of the plurality of even stage gate COFs other than the first even stage gate COF drive each even stage scan output channel correspondingly according to another scan drive signal.

10. The gate driver structure of claim 7, wherein a drive manner of each odd stage scan output channel of the plurality of odd stage gate COFs and each even stage scan output channel of the plurality of even stage gate COFs is driving each other alternatively.

11. The gate driver structure of claim 7, wherein the first start signal comprises an initial pulse vertical signal, the initial pulse vertical signal being used as a start-up signal of each refreshed screen of the odd stage gate COF.
